(19) United States
(12) Patent Application Publication
(10) Pub. No.: US 2023/0359864 A1
(43) Pub. Date: Nov. 9, 2023

(54) LARGE-SCALE MATRIX OPERATIONS ON HARDWARE ACCELERATORS

(71) Applicants: Siemens Corporation, Washington, DC (US); SIEMENS INDUSTRY, INC., Alpharetta, GA (US)

(72) Inventors: Martin Sehr, Kensington, CA (US); Eugen Solowjow, Berkeley, CA (US); Wei Xi Xia, Daly City, CA (US); Shashank Tamaskar, Mohali, Punjab (IN); Ines Ugalde Diaz, Redwood City, CA (US); Heiko Claussen, Wayland, MA (US); Juan L. Aparicio Ojea, Moraga, CA (US)

(73) Assignee: Siemens Corporation, Washington, DC (US)

(21) Appl. No.: 18/043,400

(22) PCT Filed: Aug. 31, 2020
(86) PCT No.: PCT/US2020/048735

§ 371 Date: Feb. 28, 2023

(51) Int. Cl. G06N 3/045

(52) U.S. Cl. CPC G06N 3/045; G05B 13/027

(57) ABSTRACT

An edge device can be configured to perform industrial control operations within a production environment that defines a physical location. The edge device can include a plurality of neural network layers that define a deep neural network. The edge device be configured to obtain data from one or more sensors at the physical location defined by the production environment. The edge device can be further configured to perform one or more matrix operations on the data using the plurality of neural network layers so as to generate a large scale matrix computation at the physical location defined by the production environment. In some examples, the edge device can send the large scale matrix computation to a digital twin simulation model associated with the production environment, so as to update the digital twin simulation model in real time.

### BACKGROUND

As industrial automation has developed, some factories have become more customized, while technology development often seeks to enable autonomous and intelligent solutions having long-term adaptability. For example, a technical challenge in developing such technology relates to bridging the gap between theory and industrial practice for, in some cases, safety-critical applications that can involve machine learning technologies (e.g., deep neural networks). It is recognized herein that a variety of technical challenges remain related deploying safe learning and intelligent control systems applicable to practical cases in industrial automation. As an example, such intelligent control systems, for instance intelligent industrial automation systems that include deep neural networks, often require significant computation resources. Current approaches to deploying such systems so that the systems have adequate computation resources lack efficiencies and capabilities.

### BRIEF SUMMARY

Embodiments of the invention address and overcome one or more of the described-herein shortcomings by providing methods, systems, and apparatuses that can perform large scale matrix operations on edge devise within industrial control systems.

In an example aspect, an industrial control system (ICS) includes a production network configured to perform automated control operations. An edge device can be configured to perform industrial control operations within a production environment that defines a physical location. The edge device can include a plurality of neural network layers that define a deep neural network. The edge device can further include a processor, and a memory storing instructions that, when executed by the processor, cause the edge device to obtain data from one or more sensors at the physical location defined by the production environment. The edge device can be further configured to perform one or more matrix operations on the data using the plurality of neural network layers so as to generate a large scale matrix computation at the physical location defined by the production environment. In some examples, the edge device can send the large scale matrix computation to a digital twin simulation model associated with the production environment, so as to update the digital twin simulation model in real time.

### BRIEF DESCRIPTION OF THE SEVERAL VIEWS OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a block diagram of an example industrial control system (ICS) in accordance with an example embodiment.

FIG. 2 is a flow diagram of operations that can be performed by the hardware accelerator, in accordance with an example embodiment.

FIG. 3 illustrates a computing environment within which embodiments of the disclosure may be implemented.

### DETAILED DESCRIPTION

As an initial matter, it is recognized herein that a challenge in adopting various computationally expensive techniques, such as deep neural networks, in industrial automation is that there is often inadequate computational resources on a factory floor. For example, deep neural networks can involve training, parameterization, and execution that are computationally expensive. Further, while some computations can be performed on cloud computing infrastructure, it is recognized herein that industrial automation data can be highly sensitive with respect to timing and privacy. Such sensitivity, among other properties of industrial automation, can result in a requirement for specialized edge computing capabilities. In an example embodiment, an industrial system can include dedicated edge devices that enable deep neural networks to be executed on local hardware in direct proximity to robots and other machines. In particular, a hardware accelerator, for example a technology module (TM) neural processing unit (NPU), can be deployed within an industrial network, for instance on a factory floor. The NPU can include an optimized artificial intelligence (AI) hardware accelerator that allows rapid execution of deep neural networks embedded in an overarching automation framework, so as to be configured to interface with programmable logic controllers (PLCs) and other devices over industrial automation networks, such as PROFINET for example.

The hardware accelerator 106, for instance the NPU, can include the computational resources necessary to execute deep neural networks rapidly across various environments. It is recognized herein, however, that the industrial NPU and neural network devices used in non-industrial applications are typically used for neural network computations by loading neural networks onto device memory. In accordance with various embodiments described herein, AI hardware, in particular the NPU for example, can be configured to exploit specialized hardware so as to perform various resource-heavy computation tasks. An example of such computation tasks is large-scale matrix operations, for instance multiplication or computation of inverses so as to perform control operations or state estimations. Such computations are necessary in a wide range of industrial automation applications. By way of example, embodiments described herein can perform concurrent state estimation for continuous-state systems, such as in temperature fields, material stresses, or fluid movement. It will be understood that the various implementations are presented to illustrate examples. That is, hardware accelerators (e.g., the NPU) can be applied to other industrial automation tasks as desired, for instance other tasks requiring rapid manipulation of large matrices, and all such implementations are contemplated as being within the scope of this disclosure. In an example embodiment, the NPU can be configured to rapidly perform large-scale matrix operations in addition to running neural networks.

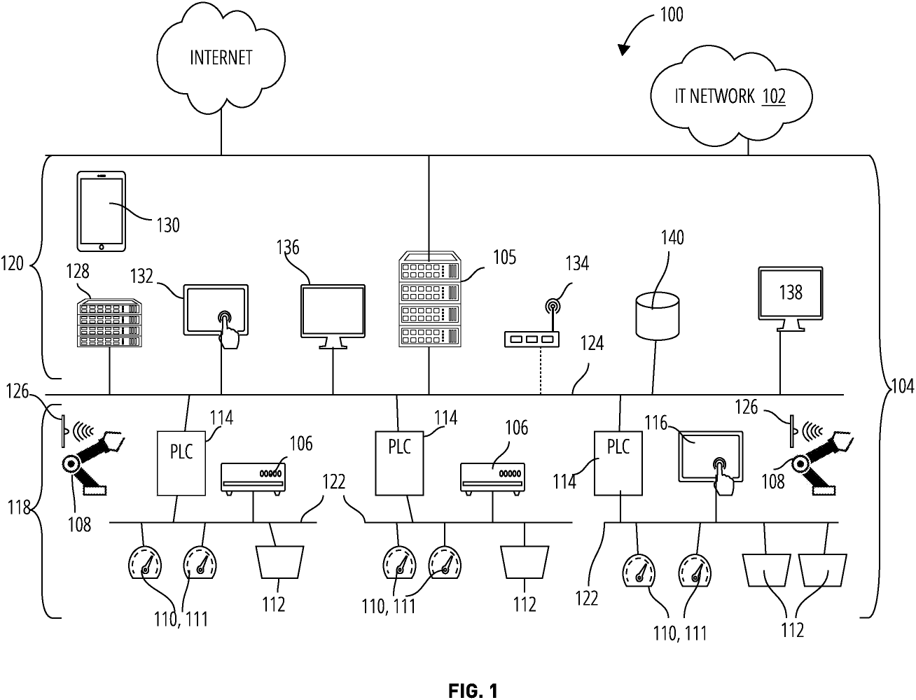

Referring initially to FIG. 1, an example distributed control system (DCS) or industrial control system (ICS) 100 includes an office or corporate IT network 102 and an operational plant or production network 104 communicatively coupled to the IT network 102. The production network 104 can define a production environment within a factory or operational facility. Thus, the production environment can define a physical location. The production network 104 can include a server 105 that is connected to the IT network. The production network can further include an artificial intelligence (AI) hardware accelerator 106 that defines an edge device. The production network 104 can include various production machines configured to work together to perform one or more manufacturing operations. Example production machines of the production network 104 can include, without limitation, robots 108 and other field devices, such as sensors 110, actuators 112, or other machines, which can be controlled by a respective PLC 114. The PLC 114 can send instructions to respective field devices. In some cases, a given PLC 114 can be coupled to a human machine interfaces (HMIs) 116. It will be understood that the ICS 100 is simplified for purposes of example. That is, the ICS 100 may include additional or alternative nodes or systems, for instance other network devices, that define alternative configurations, and all such configurations are contemplated as being within the scope of this disclosure.

The ICS 100, in particular the production network 104, can define a fieldbus portion 118 and an Ethernet portion 120. For example, the fieldbus portion 118 can include the robots 108, PLC 114, sensors 110, actuators 112, and HMIs 116. The fieldbus portion 118 can define one or more production cells or control zones. In some examples, the fieldbus portion 118 can further include the hardware accelerator 106 that can be configured to communicate with a given PLC 114 and sensors 110. In some cases, the PLC 114 can define the hardware accelerator 106. In an example, the hardware accelerator 106 can define a neural network that can run on a stand-alone ruggedized computer or can be integrated with existing accelerators that can be close to, and coupled with, PLCs 114. In some cases, the hardware accelerator defines small footprint, passive-cooled technology module on the PLC 114. The PLC 114, hardware accelerator 106, sensors 110, actuators 112, and HMI 116 within a given production cell can communicate with each other via a respective field bus 122. Each control zone can be defined by a respective PLC 114, such that the PLC 114, and thus the corresponding control zone, can connect to the Ethernet portion 120 via an Ethernet connection 124. The robots 108 can be configured to communicate with other devices within the fieldbus portion 118 via a Wi-Fi connection 126. Similarly, the robots 108 can communicate with the Ethernet portion 120, in particular a Supervisory Control and Data Acquisition (SCADA) server 128, via the Wi-Fi connection 126. The Ethernet portion 120 of the production network 104 can include various computing devices communicatively coupled together via the Ethernet connection 124. Example computing devices in the Ethernet portion 120 include, without limitation, a mobile data collector 130, HMIs 132, the SCADA server 128, the ICS-PIAE 106, a wireless router 134, a manufacturing execution system (MES) 136, an engineering system (ES) 138, and a log server 140. The ES 138 can include one or more engineering works stations. In an example, the MES 136, HMIs 132, ES 138, and log server 140 are connected to the production network 104 directly. The wireless router 134 can also connect to the production network 104 directly. Thus, in some cases, mobile users, for instance the mobile data collector 130 and robots 108, can connect to the production network 104 via the wireless router 134. In some cases, by way of example, the ES 138 and the mobile data collector 130 define guest devices that are allowed to connect to the hardware accelerator 106. It will be understood that guest devices to the production network 104 can vary as desired.

The production network 104 can define a neural network system, for instance a neural network system. The neural network system can include the AI hardware accelerator 106, for instance a technology module (TM) neural processing unit (NPU). In various example implementations, the NPU can be configured for deep learning acceleration for images, videos and time series streams. Thus, the NPU can be used for, for example and without limitation, visual quality assessment, tracking of object locations and poses, object detection and tracking, counting, reading text, real-time process optimization, flexible robotic grasp computations, audio-based condition monitoring, and virtual sensing (e.g., estimation of weight and shelf life of a fruit based on a picture). The NPU can define an edge device within the production network 104. In an example, the neural network system can include a PLC 114 that includes a controller that can process data from sensors or cameras. The PLC 114 can send the collected data to the NPU. In some cases, the NPU defines a technology module within the PLC 114. The NPU can be trained on the data so as to learn the data and make predictions based on data. In particular, the NPU can define a deep neural network having a plurality of neural network layers. The neural network system can further include an input/output (I/O) device interface for communicating with the controller of the PLC 114, for instance via the PROFINET protocol. The neural network system can further include I/O modules to collect sensor data and send out control signals. In an example, I/O device interfaces are connected to the PLC 114 through a network switch. The neural network system can also include an RGB camera that can be connected to the PLC 114 for image detection.

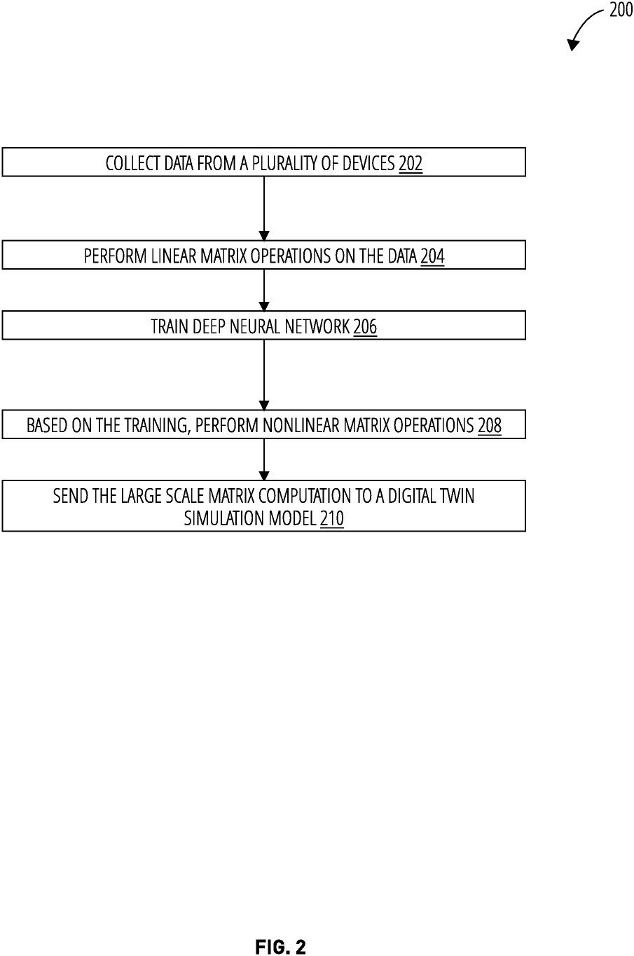

Referring now to FIG. 2, an example method 200 is shown that can be performed by an edge device within the production network 104, for instance by the hardware accelerator 106. In some cases, the NPU defines an AI hardware accelerator that is optimized for the performance of deep neural networks. Thus, in accordance with various examples, the matrix operations can be represented as exact or approximate neural networks, such that the deep neural network optimized NPU can perform the matrix operations.

It is recognized herein various operations that the hardware accelerator 106 performs internally when executing deep neural networks can be described by linear algebra. Similarly, in various examples, this connection can be reversed so as to generate neural networks that can perform a specific set of desired linear algebra operations. For example, a single-layer network with linear activation functions can be used to execute the operation y = Ax + b, where A is a matrix, and x, y and b are vectors of appropriate dimensions. That is, in some examples, at 204, any linear matrix operation can be encoded in a single-layer neural network, which consequently can be executed on AI hardware accelerators such as the hardware accelerator 106. It is further recognized herein that the above example can be extended to the multiplication of matrices. For example, the hardware accelerator 106 can also execute the operation Y = AX + B, where A, X, Y and B are matrices of appropriate dimensions. In various examples, any operation that can be expressed or approximated by linear operation can be encoded in a neural network for use on AI hardware accelerators, such as the hardware accelerator 106. It will be understood the above linear operations are presented as simple illustrative examples, and that more complicated operations can be performed by successive matrix multiplication and addition, such as when using powerful matrix decompositions (e.g. LU, QR, Schur, Cholesky, SVD, etc.), and all such operations are contemplated as being within the scope of this disclosure. In some cases, matrix decompositions may be obtained offline so as to allow complex operations to be performed online based on process data. In various examples, matrix decompositions may also be used to spread operations, such as the above example operations, across multiple layers of a neural network. Thus, the hardware accelerator 106 can be implemented in a variety of applications in accordance with various embodiments.

As an example of linear operations that can be encoded in neural networks of the hardware accelerator 106, so to approximate more complex matrix operations, approximate computation of a matrix inverse using Newtons method is now described. In particular, Xₖ₊₁ = 2Xₖ - XₖAXₖ, where k is the iteration and Xₖ iteratively approximates the inverse of A. The approach stops when Xₖ₊₁ and Xₖ converge. In the example, this algorithm is converted to the previously discussed format of Y = AX + B. The conversion can be performed by first computing Y = - AXₖ + 2I, and then computing Xₖ₊1 = XₖY, where I is the identity matrix. It is recognized herein that this approach is a particularly good fit for a neural network accelerator, in particular the NPU, when a fixed number of iterations lead to a good inverse matrix approximation because, for example, the operations can be concatenated to a larger neural network to achieve the result. In an alternative example, a smaller neural network representing one iteration of the algorithm can be implemented and run iteratively until convergence. In an example, the dedicated hardware acceleration of the NPU for the required linear algebra operation can result in an efficient computation, while also providing a second output indicating the accuracy of the inverse estimation.

In other cases, certain complex nonlinear matrix operations might not be easily expressed as linear operations as in the example above. In such cases, however, the operations can be approximated by training a deep neural network (at 206) to closely match the desired input-output relationship, in accordance with an embodiment. Thus, such approximate matrix operations can be performed on dedicated AI hardware accelerators, such as the NPU, at 208. This training to approximate matrix operations can also be performed by the NPU when representation of specific operations in a neural network is possible but requires neural networks of excessive size.

In an example, a matrix operation can be compressed in the neural network system by providing examples to the network, for instance millions of examples. Such examples can be provided offline so as to train the neural network for image recognition, among other uses. By way of example, consider training a neural network for computing 4x4 inverse matrices. In an example, a suitable neural network architecture (e.g., having 16 inputs and 16 outputs and 4 layers) can receive data from standard examples of matrices and inverses. The data can be applied to the network so to compute the parameters via back-propagation. Alternatively, a problem-dependent estimator can be used. For example, in some cases, there is a complex physics relationship between a number of sensor inputs and a desired output. An example formula can include a number of partial derivations. Therefore, in various examples, data from use cases can be used, for instance around the operational point (input and output), so as to train a neural network, which can then approximate a result for a given set point. In various examples, it is recognized herein that such approximations can define a compressed representation for a problem at hand that is more computationally efficient to solve as compared to standard approaches.

As another example of how the hardware accelerator 106 can perform computationally expensive operations in an industrial system, an example real-time monitoring application is now considered. In the example real-time monitoring application, data observations can be taken periodically or sporadically, for instance by the sensors 110. In particular, as an example, the data observations can include surface quantities pertaining to a field over some object volume, such as measuring surface temperatures of an object being heated. This example can represent a common problem across different manufacturing processes, such as additive manufacturing. Further, in some cases, access to interior temperatures or other field quantities is extremely challenging based on availability of only surface measurement data. Such a problem can be alleviated by digital twin simulation models that are updated at real-time so as to track the desired field quantities. It is recognized herein, however, that these models often require some form of discretization over the object volume, which can lead to large arrays of discrete points at which the various quantities are tracked over time. This in turn can require manipulation of very large matrices, for instance matrices having millions of rows and columns. Further, in various use cases, such as when the quantities pertain to safety-critical and high-value processes, these large scale matrix operations must be performed both accurately and in rapid succession. Thus, as described above, such computations might not be able to be performed within the time constraints by using cloud resources. Such computations can, however, be performed on edge devices such as the hardware accelerator 106, thereby enabling the above-described digital twin models, among other industrial applications involving computationally expensive operations.

In various examples, the digital twin implementation described above can be applied to processes in addition to high value or safety critical processes. The hardware accelerator 106 can work with various digital twins that define complex processes that require real-time optimization. By way of example, in various additive manufacturing use cases, complex surfaces are printed, which can result in temperature distributions that are difficult to estimate based on surface temperatures. Such estimations can be critical to limit tensions or delamination in lower levels of the material. Therefore, in some cases, computations cannot include long or undefined latencies, such as might be performed on the cloud. Therefore, in an example, the hardware accelerator 106 can provide real-time evaluation of the digital twin so as to define temperature, location, speed, etc. related to when a next layer can be added in an additive manufacturing operation.

Thus, as described herein, referring in particular to FIG. 2, an edge device within an industrial control system can perform industrial control operations within a production environment that defines a physical location. At 202, the edge device can obtain data from one or more sensors at the physical location defined by the production environment. The edge device can perform one or more matrix operations on the data using a plurality of neural network layers of the edge device, so as to generate a large scale matrix computation at the physical location defined by the production environment. For example, at 204, the edge device can perform a plurality of linear matrix operations on the data so as to generate the large scale matrix computation. In some cases, each linear matrix operation can be performed on a respective layer of the plurality of neural network layers. For example, an algorithm associated with the data can be encoded into the plurality of linear matrix operations. In another example, based on the data, the edge device can decompose a matrix so as to define a matrix decomposition. The edge device can further perform the one or more matrix operations on the matrix decomposition across multiple layers of the plurality of neural network layers. At 206, the deep neural network of the edge device can be trained to predict outputs of nonlinear matrix operations. At 208, based on the training, the edge device can generate an approximation of a nonlinear matrix operation on the data. The approximation can define the large scale matrix computation. At 210, in accordance with various examples, the edge device can send the large scale matrix computation to a digital twin simulation model associated with the production environment, so as to update the digital twin simulation model in real time.

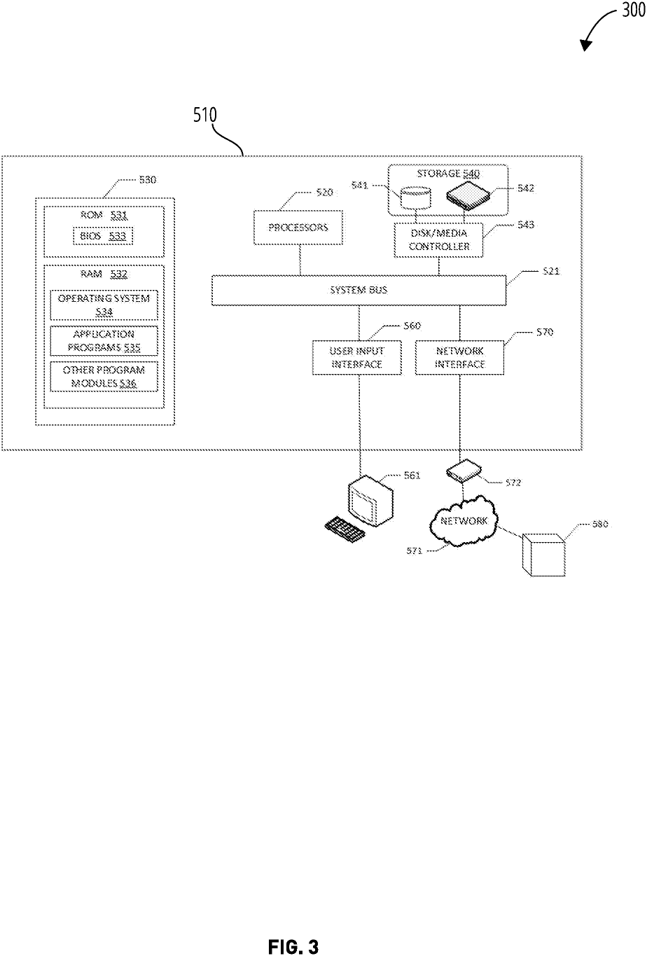

FIG. 3 illustrates an example of a computing environment within which embodiments of the present disclosure may be implemented. A computing environment 300 includes a computer system 510 that may include a communication mechanism such as a system bus 521 or other communication mechanism for communicating information within the computer system 510. The computer system 510 further includes one or more processors 520 coupled with the system bus 521 for processing the information. The hardware accelerator 106 may include, or be coupled to, the one or more processors 520.

The processors 520 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 520 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 521 may include at least one of a system bus, a memory bus, an address bus, or a message bus, and may permit exchange of information (e.g., data (including computer-executable code), signaling, etc.) between various components of the computer system 510. The system bus 521 may include, without limitation, a memory bus or a memory controller, a peripheral bus, an accelerated graphics port, and so forth. The system bus 521 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 3, the computer system 510 may also include a system memory 530 coupled to the system bus 521 for storing information and instructions to be executed by processors 520. The system memory 530 may include computer readable storage media in the form of volatile and/or nonvolatile memory, such as read only memory (ROM) 531 and/or random access memory (RAM) 532. The RAM 532 may include other dynamic storage device(s) (e.g., dynamic RAM, static RAM, and synchronous DRAM). The ROM 531 may include other static storage device(s) (e.g., programmable ROM, erasable PROM, and electrically erasable PROM). In addition, the system memory 530 may be used for storing temporary variables or other intermediate information during the execution of instructions by the processors 520. A basic input/output system 533 (BIOS) containing the basic routines that help to transfer information between elements within computer system 510, such as during start-up, may be stored in the ROM 531. RAM 532 may contain data and/or program modules that are immediately accessible to and/or presently being operated on by the processors 520. System memory 530 may additionally include, for example, operating system 534, application programs 535, and other program modules 536. Application programs 535 may also include a user portal for development of the application program, allowing input parameters to be entered and modified as necessary.

The operating system 534 may be loaded into the memory 530 and may provide an interface between other application software executing on the computer system 510 and hardware resources of the computer system 510. More specifically, the operating system 534 may include a set of computer-executable instructions for managing hardware resources of the computer system 510 and for providing common services to other application programs (e.g., managing memory allocation among various application programs). In certain example embodiments, the operating system 534 may control execution of one or more of the program modules depicted as being stored in the data storage 540. The operating system 534 may include any operating system now known or which may be developed in the future including, but not limited to, any server operating system, any mainframe operating system, or any other proprietary or non-proprietary operating system.

The computer system 510 may also include a disk/media controller 543 coupled to the system bus 521 to control one or more storage devices for storing information and instructions, such as a magnetic hard disk 541 and/or a removable media drive 542 (e.g., floppy disk drive, compact disc drive, tape drive, flash drive, and/or solid state drive). Storage devices 540 may be added to the computer system 510 using an appropriate device interface (e.g., a small computer system interface (SCSI), integrated device electronics (IDE), Universal Serial Bus (USB), or FireWire). Storage devices 541, 542 may be external to the computer system 510.

The computer system 510 may also include a field device interface 565 coupled to the system bus 521 to control a field device 566, such as a device used in a production line. The computer system 510 may include a user input interface or GUI 561, which may comprise one or more input devices, such as a keyboard, touchscreen, tablet and/or a pointing device, for interacting with a computer user and providing information to the processors 520.

The computer system 510 may perform a portion or all of the processing steps of embodiments of the invention in response to the processors 520 executing one or more sequences of one or more instructions contained in a memory, such as the system memory 530. Such instructions may be read into the system memory 530 from another computer readable medium of storage 540, such as the magnetic hard disk 541 or the removable media drive 542. The magnetic hard disk 541 and/or removable media drive 542 may contain one or more data stores and data files used by embodiments of the present disclosure. The data store 540 may include, but are not limited to, databases (e.g., relational, object-oriented, etc.), file systems, flat files, distributed data stores in which data is stored on more than one node of a computer network, peer-to-peer network data stores, or the like. The data stores may store various types of data such as, for example, skill data, sensor data, or any other data generated in accordance with the embodiments of the disclosure. Data store contents and data files may be encrypted to improve security. The processors 520 may also be employed in a multi-processing arrangement to execute the one or more sequences of instructions contained in system memory 530. In alternative embodiments, hard-wired circuitry may be used in place of or in combination with software instructions. Thus, embodiments are not limited to any specific combination of hardware circuitry and software.

As stated above, the computer system 510 may include at least one computer readable medium or memory for holding instructions programmed according to embodiments of the invention and for containing data structures, tables, records, or other data described herein. The term “computer readable medium” as used herein refers to any medium that participates in providing instructions to the processors 520 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 541 or removable media drive 542. Non-limiting examples of volatile media include dynamic memory, such as system memory 530. Non-limiting examples of transmission media include coaxial cables, copper wire, and fiber optics, including the wires that make up the system bus 521. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 300 may further include the computer system 510 operating in a networked environment using logical connections to one or more remote computers, such as remote computing device 580. The network interface 570 may enable communication, for example, with other remote devices 580 or systems and/or the storage devices 541, 542 via the network 571. Remote computing device 580 may be a personal computer (laptop or desktop), a mobile device, a server, a router, a network PC, a peer device or other common network node, and typically includes many or all of the elements described above relative to computer system 510. When used in a networking environment, computer system 510 may include modem 572 for establishing communications over a network 571, such as the Internet. Modem 572 may be connected to system bus 521 via user network interface 570, or via another appropriate mechanism.

Network 571 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 510 and other computers (e.g., remote computing device 580). The network 571 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 571.

It should be appreciated that the program modules, applications, computer-executable instructions, code, or the like depicted in FIG. 3 as being stored in the system memory 530 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 510, the remote device 580, and/or hosted on other computing device(s) accessible via one or more of the network(s) 571, may be provided to support functionality provided by the program modules, applications, or computer-executable code depicted in FIG. 3 and/or additional or alternate functionality. Further, functionality may be modularized differently such that processing described as being supported collectively by the collection of program modules depicted in FIG. 3 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 3 may be implemented, at least partially, in hardware and/or firmware across any number of devices.

It should further be appreciated that the computer system 510 may include alternate and/or additional hardware, software, or firmware components beyond those described or depicted without departing from the scope of the disclosure. More particularly, it should be appreciated that software, firmware, or hardware components depicted as forming part of the computer system 510 are merely illustrative and that some components may not be present or additional components may be provided in various embodiments. While various illustrative program modules have been depicted and described as software modules stored in system memory 530, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. An edge device configured to perform industrial control operations within a production environment that defines a physical location, the edge device comprising:
a plurality of neural network layers that define a deep neural network;
a processor; and
a memory storing instructions that, when executed by the processor, cause the edge device to:
obtain data from one or more sensors at the physical location defined by the production environment; and
perform one or more matrix operations on the data using the plurality of neural network layers so as to generate a large scale matrix computation at the physical location defined by the production environment.

2. The edge device of claim 1, the memory further storing instructions that, when executed by the processor, further cause the edge device to:
perform a plurality of linear matrix operations on the data so as to generate the large scale matrix computation, each linear matrix operation performed on a respective layer of the plurality of neural network layers.

3. The edge device of claim 2, the memory further storing instructions that, when executed by the processor, further cause the edge device to:
encoding an algorithm associated with the data into the plurality of linear matrix operations.

4. The edge device of claim 1, the memory further storing instructions that, when executed by the processor, further cause the edge device to:
based on the data, decompose a matrix so as to define a matrix decomposition; and
perform the one or more matrix operations on the matrix decomposition across multiple layers of the plurality of neural network layers.

5. The edge device of claim 1, the memory further storing instructions that, when executed by the processor, further cause the edge device to:
train the deep neural network of the edge device to predict outputs of nonlinear matrix operations; and
based on the training, generate an approximation of a nonlinear matrix operation on the data, the approximation defining the large scale matrix computation.

6. The edge device of any one of the preceding claims, the memory further storing instructions that, when executed by the processor, further cause the edge device to:
send the large scale matrix computation to a digital twin simulation model associated with the production environment, so as to update the digital twin simulation model in real time.

7. A method performed by an edge device within an industrial control system perform industrial control operations within a production environment that defines a physical location, the method comprising:
obtaining data from one or more sensors at the physical location defined by the production environment; and
perform one or more matrix operations on the data using a plurality of neural network layers of the edge device, so as to generate a large scale matrix computation at the physical location defined by the production environment.

8. The method of claim 7, the method further comprising:
performing a plurality of linear matrix operations on the data so as to generate the large scale matrix computation, each linear matrix operation performed on a respective layer of the plurality of neural network layers.

9. The method of claim 7, the method further comprising:
encoding an algorithm associated with the data into the plurality of linear matrix operations.

10. The method of claim 7, the method further comprising:
based on the data, decomposing a matrix so as to define a matrix decomposition; and
performing the one or more matrix operations on the matrix decomposition across multiple layers of the plurality of neural network layers.

11. The method of claim 7, the method further comprising:
training the deep neural network of the edge device to predict outputs of nonlinear matrix operations; and
based on the training, generating an approximation of a nonlinear matrix operation on the data, the approximation defining the large scale matrix computation.

12. The method as recited in any one of claims 7 to 11, the method further comprising:
sending the large scale matrix computation to a digital twin simulation model associated with the production environment, so as to update the digital twin simulation model in real time.

13. A non-transitory machine-readable medium comprising instructions that, when executed by a processor, cause an edge device within a production environment that defines a physical location to:
obtain data from one or more sensors at the physical location defined by the production environment; and
perform one or more matrix operations on the data using a plurality of neural network layers so as to generate a large scale matrix computation at the physical location defined by the production environment.

14. The non-transitory machine-readable medium of claim 13, further comprising instructions that, when executed by the processor, cause the computing system to:
perform a plurality of linear matrix operations on the data so as to generate the large scale matrix computation, each linear matrix operation performed on a respective layer of the plurality of neural network layers.

15. The non-transitory machine-readable medium of claim 13, further comprising instructions that, when executed by the processor, cause the computing system to:
train a deep neural network of the edge device to predict outputs of nonlinear matrix operations; and
based on the training, generate an approximation of a nonlinear matrix operation on the data, the approximation defining the large scale matrix computation.
